(19) United States
(12) Patent Application Publication
(10) Pub. No.: US 2014/0368614 A1
(43) Pub. Date: Dec. 18, 2014

(54) THREE DIMENSIONAL SCANNING APPARATUSES AND METHODS FOR ADJUSTING THREE DIMENSIONAL SCANNING APPARATUSES

(71) Applicant: EDGE TOY, INC., TORRANCE, CA (US)

(72) Inventors: OSAMU SCOTT IMAI, REDONDO BEACH, CA (US); STUART KEVIN IMAI, RANCHO PALOS VERDES, CA (US)

(21) Appl. No.: 14/303,525

(22) Filed: Jun. 12, 2014

Related U.S. Application Data
(60) Provisional application No. 61/834,800, filed on Jun. 13, 2013.

(51) Int. Cl. H04N 13/02

(52) U.S. Cl. CPC H04N 13/0246
USPC 348/47

(57) ABSTRACT

A three dimensional scanning apparatuses and methods of calibrating such apparatuses. The apparatus included a camera moveable along a first longitudinal axis, and a projector moveable along a second longitudinal axis which is parallel or coincident with the first longitudinal axis. Movement of one of the camera and projector along its corresponding longitudinal axis toward the other of the camera and projector causes the other of said camera and projector to move along its corresponding longitudinal axis toward the one of said camera and projector.

### CROSS-REFERENCE TO RELATED APPLICATION

This application claims priority to and the benefit of Provisional Application No. 61/834,800, filed on Jun. 13, 2013, the entire disclosure of which is incorporated herein by reference.

### BACKGROUND

The present disclosure relates to apparatuses used in three-dimensional (“3D”) structured light scanning and more specifically to apparatuses for symmetrically moving the camera and projector, or cameras, and to methods for achieving the symmetrical and synchronized placement of a camera and projector, or cameras, while maintaining a fixed angle of the camera and projector, or cameras.

Structured-light 3D scanners or 3D scanning apparatuses also known as white-light scanners, project a series of patterns of black and white lines using a projector. The projected pattern follows and deforms as it is projected onto the contour of the object being scanned. The camera(s) is offset from the projector allowing it to capture the shape and data of the contoured lines. The data is later stitched or merged into a 3-dimensional (3D) object that can be used with a variety of 3D computer software programs. Structured-light scanning typically uses one or two cameras, in addition to one projector.

The current structured-light scanning methods of adjusting optical devices such as projectors and cameras are limited and somewhat archaic. Separate tripods are the typical means to mount, stabilize, raise and lower each camera and projector component. The camera(s) and projector must be set at a specified fixed angle to each other. This fixed angle allows the camera(s) to capture the data image of the contour lines at a different viewing angle of the pattern projected from the projector. Without this fixed angle, the contour lines become less discernible by the camera(s) as they are projected on an uneven surface of the object being scanned. As the angle and optical axis' between the camera(s) lens and projector lens decreases becoming more parallel with each other, the contour lines appear straighter and therefore, the camera(s) cannot capture the distorted projection lines that make up the contour of the object being scanned.

The distance between the camera(s) and projector is dependent on the size of the object or the area being scanned. Also critical is the distance of the object being scanned in relationship to the location of the camera(s) and projector. To achieve this distance, the user must manually move and adjust the camera(s) and projector typically mounted on a tripod, either closer or apart from each other, and then move those optical devices closer or farther from the object being scanned, all while trying to maintain the fixed angle of the camera(s) and projector. This is very hard to achieve, and more importantly, it is harder to replicate these positions at a later time if the same object needs to be rescanned.

Another example of a 3D structured-light scanning apparatus is the use of long metal extrusions with a series of holes the user then manually screws the camera(s) and projector onto. The fixed angle of the camera(s) and projector is not guaranteed and the user is limited to the manufactured spacing of the holes in order to screw the camera(s) and projector in place. The extrusion is then placed on a tripod to allow for height adjustment and further stability. Another method would be to place the camera(s) and projector on raised objects such as a stack of books, blocks, boxes, etc., further compromising accuracy.

There are limitations to these methods, and none of these methods allow the user to conveniently and efficiently adjust the optical devices such as a camera and projector, or cameras, apart from each other, while keeping the fixed angle between the optical devices, all in one symmetrical and synchronized motion. Additionally, none of these methods allow the user to accurately replicate the distance between optical devices such as a camera and projector, or multiple cameras in relationship to the specific object being scanned. Additionally, none of these methods allow the user to accurately replicate the distance between the optical devices to the actual object being scanned in one simple operation. Therefore, it would be advantageous to provide a method and an apparatus for mounting optical devices such as cameras and projectors, to be used in 3D structured-light scanning, further allowing the user to possibly infinitely adjust the distance between optical devices such as cameras and projector in one symmetrical and synchronized motion while keeping cameras and projector at fixed angles towards each other. There is currently no scanning apparatus that uniformly adjusts the distance of optical devices, such as a camera and projector, or multiple cameras, apart from each other, using a mechanism to symmetrically move the optical devices, equally apart from each other, in one continuous synchronized motion, while keeping the optical devices at a fixed angle, and on the same planes.

### SUMMARY

Three-dimensional scanning apparatuses and methods for symmetrically adjusting distances between optical devices such as cameras and projectors at fixed angles, for use in 3D structured-light scanning, and for determining the distance between the object being scanned by the optical devices, using a symmetrical and synchronized adjustment are provided.

In one example embodiment a three dimensional scanning apparatus is provided. The 3D scanning apparatus includes a camera moveable along a first longitudinal axis, and a projector moveable along a second longitudinal axis which is parallel or coincident with the first longitudinal axis, and movement of one of the camera and projector along its corresponding longitudinal axis toward the other of the camera and projector causes the other of the camera and projector to move along its corresponding longitudinal axis toward the one of the camera and projector.

In another example embodiment a three dimensional scanning apparatus is provided. This example embodiment 3D scanning apparatus includes a first camera moveable along a first longitudinal axis, a second camera moveable along a second longitudinal axis which is parallel or coincident with the first longitudinal axis, and movement of the first camera along the first longitudinal axis toward the second camera causes the second camera to move toward the first camera along the second longitudinal axis. The 3D scanning apparatus also includes a projector. In yet another example embodiment, the projector is located between the first and second cameras.

In a further example embodiment a method for calibrating the location a camera and a projector for three dimensional scanning of an object is provided. The method includes projecting a vertical line on the object, projecting a light beam parallel to an optical axis of the camera, moving the camera along a first longitudinal axis toward a projector until the light beam intersects the line, and moving the projector simultaneously with the moving of the camera toward the camera along a second longitudinal axis which is parallel or coincident with the first longitudinal axis.

In yet a further example embodiment, a method for calibrating the location of two camerals for three dimensional scanning of an object. The method includes projecting a vertical line on the object, projecting a light beam parallel to an optical axis of a first camera, moving the first camera along a first longitudinal axis toward a second camera until the light beam intersects said line, and moving the second camera simultaneously with the moving of the first camera toward the first camera along a second longitudinal axis which is parallel or coincident with the first longitudinal axis.

In one preferred exemplary embodiment, a method is provided including placing a double-opposed helical grooved shaft on a mount or frame supported by bearing surfaces, and placing an optical device such as a camera and lens onto the double-opposed helical grooved shaft, such that the camera and lens are perpendicular to the rotational axis of the double-opposed helical grooved shaft and set at a fixed angle. The housing of the camera has a longitudinal hole with a fixed collar that is mated to, and follows the rotational axis of one of the helical grooves that is cut or molded into the shaft. In the same embodiment includes placing another optical device onto the double-opposed helical grooved shaft, such as a projector and lens such that the projector and lens are perpendicular to the rotational axis of the double-opposed helical grooved shaft and set at a fixed angle. The housing of the projector has a longitudinal hole with a fixed collar that is mated to, and follows the rotational axis of the “opposing” helical groove that is cut or molded into the shaft. As the double-opposed helical grooved shaft rotates along its longitudinal axis in one direction, for example in the clockwise direction, both optical devices, such as a camera, and the other a projector, move apart from each other in a synchronized and symmetrical motion. This rotation can be actuated by use of manual hand crank, manual slide, motor, or motor with wireless capabilities. As for example, when the rotational direction of the double-opposed helical grooved shaft is reversed in a counter-clockwise motion, the optical devices move towards each other in a synchronized and symmetrical motion. The double-opposed helical grooved shaft moves in a rotational motion along its longitudinal axis. The optical devices in their housings set at fixed angles, such as cameras and projectors, move in a linear direction, apart from each other on the same plane in a synchronized and symmetrical motion, and reversing the direction of the double-opposed helical grooved shaft, will move the optical devices closer to each other.

In another exemplary embodiment, a method is provided including placing two parallel racks each with geared teeth molded into the longitudinal length of the rack and mounted to the frame. Each geared rack is separated from each other by a primary drive gear and a series of alignment gears that drive each geared rack in opposing directions when the drive gear is rotated in either direction. One optical device such as a camera and lens is coupled to one end of a geared rack such that the camera and lens are perpendicular to the longitudinal axis of the geared rack and the optical device is set at a fixed angle. In the same embodiment includes placing another optical device, such as a projector and lens such that the projector and lens are perpendicular to the longitudinal axis of the second and opposing geared rack and the optical device is set at a fixed angle. The housing of the projector, or additional camera, is coupled to the opposing end of the geared rack. The geared rack driven by the primary drive gear can be actuated by use of manual hand crank, manual slide, motor, or motor with wireless capabilities. As the primary drive gear is turned for instance in a clockwise motion, the first geared rack will move to the right, and simultaneously the second opposed geared rack will move to the left, respectively. As for example, when the primary drive gear is rotated in a counter-clockwise motion, the first geared rack will move back to the left, and the second geared rack will move back to the right, respectively. The optical devices in their housings set at fixed angles, such as cameras and projectors, move in a linear direction, apart from each other on the same plane in a synchronized and symmetrical motion, and reversing the direction of the drive gear, will move the optical devices closer to each other.

In yet a further exemplary embodiment, a method is provided including placing a continuous toothed or non-toothed belt drive on a frame with optical devices attached. For example, one optical device such as a camera and lens is coupled to the “front” straight length of a belt such that the camera and lens are perpendicular to the straight portion of the belt with the optical device set at a fixed angle. In the same embodiment includes placing another optical device, such as a projector and lens such that the projector and lens are perpendicular to the straight portion of the belt, for example, attached to the “rear” section of the same belt and the optical device is set at a fixed angle. Two pulleys separate the belt that spans roughly the width of the apparatus, creating 2 straight linear sections of belt with one optical device such as a camera coupled to one length of the belt, and the other optical device such as a projector coupled to the opposing length of the belt. The belt can be driven by the primary drive pulley and can be actuated by use of manual hand crank, manual slide, motor, or motor with wireless actuator capabilities. As the primary drive pulley is turned for instance in a clockwise motion, the first optical device will move to the right, and simultaneously the second optical device on the opposing side of the belt will move to the left, respectively, much like two race cars on opposing straight-aways, driving the same direction on the same oval-shaped racetrack. The optical devices in their housings set at fixed angles, such as cameras and projectors, move in a linear direction, apart from each other on the same plane in a synchronized and symmetrical motion, and reversing the direction of the drive pulley, will move the optical devices closer to each other.

In another exemplary embodiment, a method is provided including placing a continuous cable drive on a frame with optical devices attached. One optical device such as a camera and lens is coupled to one length of a cable, for example the “front” length, such that the camera and lens are perpendicular to the longitudinal axis of the cable and the optical device is set at a fixed angle. In the same embodiment includes placing another optical device, such as a projector and lens, for example the “rear” length, such that the projector and lens are perpendicular to the longitudinal section of the cable and the optical device is set at a fixed angle and coupled to the opposing cable. Two pulleys separate the cable that spans roughly the width of the apparatus, creating 2 straight linear sections of cable with one optical device such as a camera coupled to one length of the cable, for example on the “front” length, and the other optical device such as a projector coupled to the opposing length of the cable, for example on the “rear” length. The cable can be driven by the primary drive pulley and can be actuated by use of manual hand crank, manual slide, motor, or motor with wireless actuator capabilities. As the primary drive pulley is turned for instance in a clockwise motion, the first optical device will move to the right, and simultaneously the second optical device on the opposing side of the cable will move to the left, respectively, much like 2 race cars on opposing straight-aways, driving in the same direction on the same racetrack. The optical devices in their housings set at fixed angles, such as cameras and projectors, move in a linear direction, apart from each other on the same plane in a synchronized and symmetrical motion, and reversing the direction of the drive pulley, will move the optical devices closer to each other.

In yet another exemplary embodiment, a method is provided including placing two separate spiral-grooved shafts on a mount or frame supported by bearing surfaces, and coupling an optical device such as a camera and lens on one spiral-grooved shaft, such that the camera and lens are perpendicular to the rotational axis of the spiral-grooved shaft and set at a fixed angle. The housing of the camera has a primary longitudinal hole with a fixed collar positioned in the front of the housing that is mated to, and follows the rotational axis of the spiral-grooved shaft that is cut or molded into the shaft. The housing of the camera has a secondary longitudinal hole positioned in the rear of the housing that acts solely as a bearing surface and registration armature to restrict the housing from spinning keeping the housing parallel to the apparatus base plane at all times. In the same embodiment includes coupling another optical device onto a secondary and reversed spiral-grooved shaft, such as a projector and lens such that the projector and lens are perpendicular to the rotational axis of the reverse spiral-grooved shaft and set at a fixed angle. The housing of the projector has a primary longitudinal hole with a fixed collar positioned in the rear of the housing that is mated to, and follows the rotational axis of the reverse spiral-grooved shaft that is cut or molded into the shaft. The housing of the projector has a secondary longitudinal hole positioned in the front of the housing that acts solely as a bearing surface and registration armature to restrict the housing from spinning keeping the housing parallel to the apparatus base plane at all times. Both the spiral-grooved shaft and the reverse spiral-grooved shaft are coupled together with a primary drive gear. As the primary drive gear is turned it is coupled with the primary grooved shaft rotating along its longitudinal axis in one direction, for example in the clockwise direction, and the secondary reverse spiral-grooved shaft coupled to the same primary drive gear rotates along its longitudinal axis in the same clockwise rotation. When the rotational direction of the primary drive gear is reversed in a counter-clockwise motion, the optical devices move towards each other in a synchronized and symmetrical linear motion. In another example, this aforementioned method can be by simply coupling a drive gear to each identical spiral-grooved shaft without the use of a third drive gear. When either the primary or secondary spiral-grooved shaft is rotated for example by a knob, the opposing shaft turns in the opposite direction. This rotation can be actuated by use of manual hand crank or knob, manual slide, motor, or motor with wireless capabilities.

The following method can be included with any of the aforementioned embodiments and such methods further enhance the setup accuracy by using a laser to be coupled to one of the optical devices such as the camera and one laser coupled and centered onto the fixture. As an example, the laser coupled to the camera can project a dot pattern and is mounted parallel to and centered on the optical axis of the camera lens. This method also utilizes a secondary, stationary laser to be coupled and centered on the mount or frame of the apparatus with its optical axis perpendicular to the longitudinal length of the fixture. This secondary laser projects a vertical line pattern. For example, it is far easier to line up a laser beam that projects a dot pattern, matching it up with a secondary laser projecting a vertical line, rather than try to line up two projected dot patterns on one plane. The object to be scanned is placed in front of the scanner in a position allowing the camera to capture the desired scan area as viewed through the camera output, typically a live frame transmitted to a display device such as a computer monitor. The object to be scanned is then placed such that the vertical line laser pattern projected by the secondary laser coupled to the mount or fixture is positioned in the center of the object. As the camera is then moved along the longitudinal axis of the drive mechanisms, the laser projects a dot patterned beam from the camera housing in a lateral motion onto the object being scanned.

When the two laser beams intersect on the same plane of the object being scanned, the optical devices are then set in place relative to each other and relative to the distance between the scanner and the desired scan area of the object being scanned, and thus calibrated, and the distance setting between the optical devices such as a camera and projector, or dual cameras, is then indicated on a counter display wheel driven directly off the drive mechanism or by other means, and that number, symbol, or icon indicated on the display wheel is based on the distance the optical devices have been moved apart from each other. The distance determined between the scanner and the intersection point of the two lasers on the object being scanned can then be recorded by reading the number displayed on the display wheel. This reading on the display wheel can be used at a later time to replicate the distance settings between the scanner and scan area of a previously scanned object, thereby replicating distance based calibration settings and matching the scale of previously scanned objects, further eliminating the need to completely recalibrate the scanner.

This method using both lasers and the ability to symmetrically place the fixed-angle optical devices at the proper distance, all in one synchronized motion by means of any of the aforementioned methods, creates a triangulation system further corroborating and confirming the calibrated distance between the optical devices used in the scanning apparatus, and the distance between the scanning apparatus and the desired scan area of the object to be scanned.

The following methods can be included with any of the aforementioned embodiments. All aforementioned embodiments can use a combination of optical devices. For example, either one camera or one projector can be coupled to any of the aforementioned drive systems, or a combination of multiple cameras can be coupled to any of the aforementioned drive systems along with one centrally fixed projector. The apparatus using two cameras gathers and then combines data from two separate source angles compared to a “one camera and one projector” configuration, thus two cameras further enhances the accuracy, in effect merging twice the scanned data into the same scan. A camera(s) and projector can be manufactured and coupled to the apparatus as integrated optical devices of a production manufactured scanner, or such integrated optical devices can be replaced with existing “off-the-shelf” cameras and projectors affixed to any of the aforementioned drive systems. For descriptive purposes, “off-the-shelf” refers to any camera or projector that can be purchased through mass or specialty markets including, but not limited to digital cameras, webcams, digital single-lens reflex cameras (DSLR), machine-vision cameras, industrial cameras, digital video cameras, and all digital projectors, including but not limited to, pico projectors, LCoS technology projectors, DLP technology projectors, LED projectors, incandescent projectors, and portable digital projectors.

The following methods can be included with any of the aforementioned embodiments. All aforementioned embodiments can use a variety of actuators coupled to the drive mechanism to move the optical devices apart from each other or closer to each other during the triangulation process. For example, a drive system can be coupled to a manual knob that the user turns either clockwise or counter-clockwise to adjust the distance between optical devices. Other examples to actuate or move the drive system can be manual or mechanized, including, but, not limited to, a hand crank, a knob moved by hand, a motor, a wirelessly actuated motor with data and instructions that can be transmitted from a computer to the scanner and vice versa, or the simple act of manually sliding the optical devices apart or closer to each other by the use of hand force. As a further example, the computer and scanner can communicate to each device by a variety of hard-wired methods including, but not limited to, any USB connectors, Firewire connectors, HDMI connectors, or proprietary connectors. As yet another example of actuators, the computer and scanner can transmit data to each other using a variety of wireless technologies including, but not limited to, a wireless card, wireless technologies such as Bluetooth, or other wireless technologies.

The following methods can be included with any of the aforementioned embodiments. All aforementioned embodiments can use a combination of support systems. For example, the apparatus can be mounted on a tripod using a standard threaded insert that a majority of tripods accept. Another example to make the apparatus a stable and freestanding desktop peripheral would be the addition of either stationary or folding leg supports, or feet. As another example, the apparatus can be placed in the vertical or horizontal position when used on any surface or mounted on a tripod. One advantage to scanning vertically allows the projector to be calibrated projecting a series of patterns exactly perpendicular to the object being scanned.

The following methods can be included with all of the aforementioned embodiments. As an example, the apparatus can be used as a fully functioning fixture without an enclosed housing, or the apparatus can be contained in an enclosed housing. As an example, a fixture with an enclosed housing can enhance the function as well as the aesthetics, including, but not limited to, graphics, paint schemes, logos, switches, accessories, and storage capacity.

### BRIEF DESCRIPTION OF THE DRAWINGS

FIG. 1A is a perspective view of an example embodiment assembled 3D scanning apparatus showing the use of a double-opposed helical grooved shaft utilizing one camera and one projector.

FIG. 1B is a partially exploded view of an example embodiment 3D scanning example embodiment shown in FIG. 1A.

FIG. 1C is a close-up detail view of a section of the double-opposed helical grooved shaft on the example embodiment 3D scanning apparatus shown in FIG. 1A, FIG. 1B, FIG. 2A, and FIG. 2B.

FIG. 2A is a perspective view of another example embodiment assembled 3D scanning apparatus showing the use of a double-opposed helical grooved shaft utilizing two cameras and one projector.

FIG. 2B is a partially exploded view of the example embodiment 3D scanning apparatus shown in FIG. 2A.

FIG. 2C is a close-up detail view of a section of the double-opposed helical grooved shaft on the example embodiment 3D scanning apparatus shown in FIG. 1A, FIG. 1B, FIG. 2A, and FIG. 2B.

FIG. 3A is a perspective view of a further example embodiment assembled 3D scanning apparatus showing the use of a geared rack system utilizing one camera and one projector on yet another exemplary embodiment 3D scanning apparatus.

FIG. 3B is a partially exploded view of the example embodiment 3D scanning apparatus shown in FIG. 3A.

FIG. 4A is a perspective view of another example embodiment assembled 3D scanning apparatus showing the use of a geared rack system utilizing two cameras and one projector.

FIG. 4B is a partially exploded view on the example embodiment 3D scanning apparatus shown in FIG. 4A.

FIG. 5A is a perspective view of yet another example embodiment assembled 3D scanning apparatus showing the use of a belt drive utilizing one camera and one projector.

FIG. 5B is a partially exploded view of an example embodiment 3D scanning apparatus shown in FIG. 5A.

FIG. 6A is a perspective view of a further example embodiment assembled 3D scanning apparatus showing the use of a belt drive utilizing two cameras and one projector.

FIG. 6B is a partially exploded view of an example embodiment 3D scanning apparatus shown in FIG. 6A.

FIG. 7A is a perspective view of an example embodiment assembled 3D scanning apparatus showing the use of a cable drive utilizing one camera and one projector.

FIG. 7B is a partially exploded view of an example embodiment 3D scanning apparatus shown in FIG. 7A.

FIG. 8A is a perspective view of another example embodiment assembled 3D scanning apparatus showing the use of a cable drive utilizing two cameras and one projector.

FIG. 8B is a partially exploded view of an example embodiment 3D scanning apparatus shown in FIG. 8A.

FIG. 9A is a perspective view of an example embodiment assembled 3D scanning apparatus showing the use of a two longitudinal screw gears utilizing one camera and one projector.

FIG. 9B is a partially exploded view of an example embodiment 3D scanning apparatus shown in FIG. 9A.

FIG. 10A is a perspective view of yet a further example embodiment assembled 3D scanning apparatus showing the use of a two longitudinal screw gears utilizing two cameras and one projector.

FIG. 10B is a partially exploded view of an example embodiment 3D scanning apparatus shown in FIG. 10A.

FIG. 11A is a perspective view of an example embodiment 3D scanning apparatus showing a fixture utilizing a hand-operated slide to adjust the optical devices outward.

FIG. 11B is a perspective view of an example embodiment 3D scanning apparatus showing a fixture utilizing a hand-operated slide to adjust the optical devices inward.

FIG. 12A is a perspective view of an example embodiment 3D scanning apparatus showing a fixture with an enclosed housing utilizing a hand-operated slide to adjust the optical devices outward.

FIG. 12B is a perspective view of an example embodiment 3D scanning apparatus showing a fixture with an enclosed housing utilizing a hand-operated slide to adjust the optical devices inward.

FIG. 13A is a perspective view of an example embodiment 3D scanning apparatus fixture placed on a flat surface.

FIG. 13B is a perspective view of an example embodiment of a 3D scanning apparatus fixture enclosed in a housing placed on a flat surface.

FIG. 14A is a perspective view of an example embodiment of a 3D scanning apparatus mounted horizontally to a tripod.

FIG. 14B is a perspective view of an example embodiment of a 3D scanning apparatus mounted vertically to a tripod.

FIG. 15A is a perspective view of an example embodiment of a 3D scanning apparatus enclosed in a housing mounted horizontally to a tripod.

FIG. 15B is a perspective view of an example embodiment of a 3D scanning apparatus enclosed in a housing mounted vertically to a tripod.

FIG. 16A is a perspective view of an example embodiment motor driven 3D scanning apparatus hard-wired to a computer.

FIG. 16B is a perspective view of an example embodiment motor driven 3D scanning apparatus communicating wirelessly to a computer.

FIG. 17A is a perspective view of an example embodiment 3D scanning apparatus projecting the laser triangulation device onto an object too far away from scanner.

FIG. 17B is a perspective view of an example embodiment 3D scanning apparatus projecting the laser triangulation device onto an object in the proper distance in relationship to the scanner.

FIG. 17C is a perspective view of an example embodiment 3D scanning apparatus projecting the laser triangulation device onto an object too close to the scanner.

FIG. 18A is an orthographic view of an example embodiment 3D scanning apparatus projecting the laser triangulation device onto an object too far away from scanner.

FIG. 18B is an orthographic view of an example embodiment 3D scanning apparatus projecting the laser triangulation device onto an object the proper distance from scanner.

FIG. 18C is an orthographic view of an example embodiment depicting a top view of a 3D scanning apparatus projecting the laser triangulation device onto an object too close to the scanner.

### DETAILED DESCRIPTION

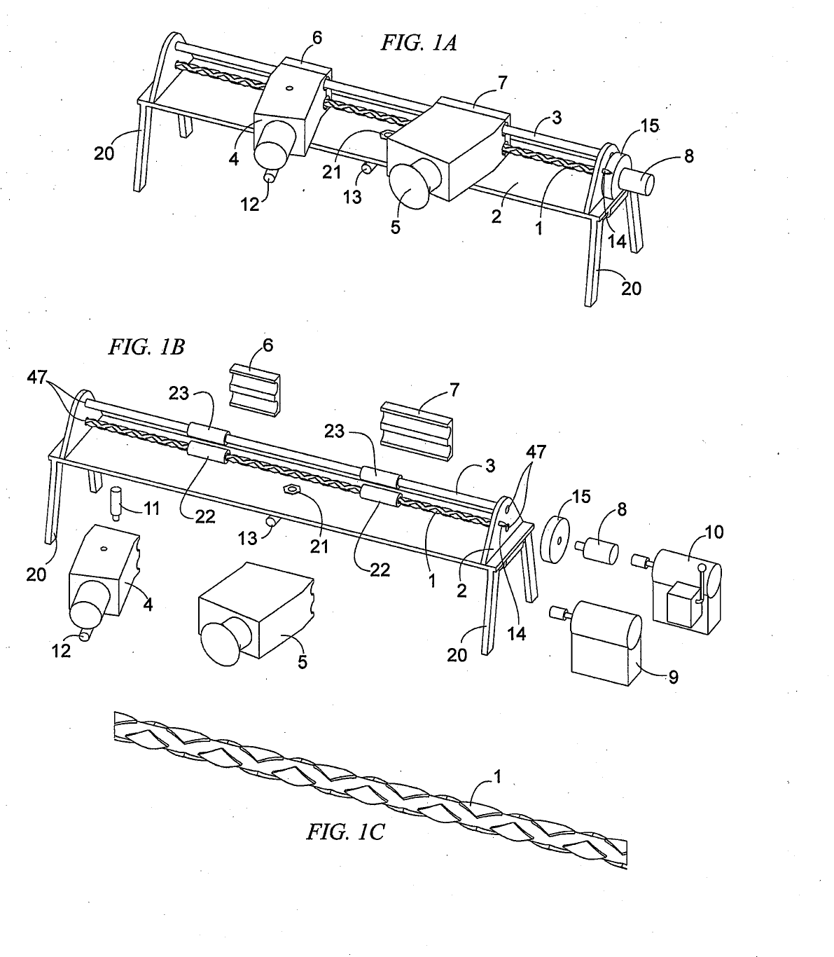

Apparatuses for symmetrically adjusting optical devices in 3D scanners, equally apart from each other, in one continuous synchronized motion, while keeping the optical devices at a fixed angle and methods for the same are provided in example embodiments. In a first exemplary embodiment, as depicted in FIGS. 1A and 1B, the double-opposed helical grooved shaft 1 and a secondary registration shaft 3 are positioned between two bearing surfaces 47 for precise location coupled to a mount or fixture 2. The double-opposed helical grooved shaft 1 and a secondary registration shaft 3 extend approximately the length of the mount or fixture 2 in a longitudinal direction, wherein the shafts 1 and 3 are mounted on opposing sides of the fixture 2 allowing a majority of shafts 1 and 3 to be unobstructed. In other embodiments, the fixture may be much longer than the shafts. A detail of the double-opposed helical grooved shaft 1 is depicted in FIG. 1C. The shaft 1 is comprised of two symmetrical and opposing spiral cuts or grooves and is the core component in this exemplary embodiment to move the optical devices in one synchronized and symmetrical motion either apart from each other 53, 54 or towards each other 55, 56.

The shaft 1 can be manufactured from suitable and rigid materials including, but not limited to, metal, plastic or composite materials. The double-opposed helical grooves on shaft 1 can be formed by production methods including, but not limited to, CNC machining, cutting processes, or molded from any of the aforementioned materials.

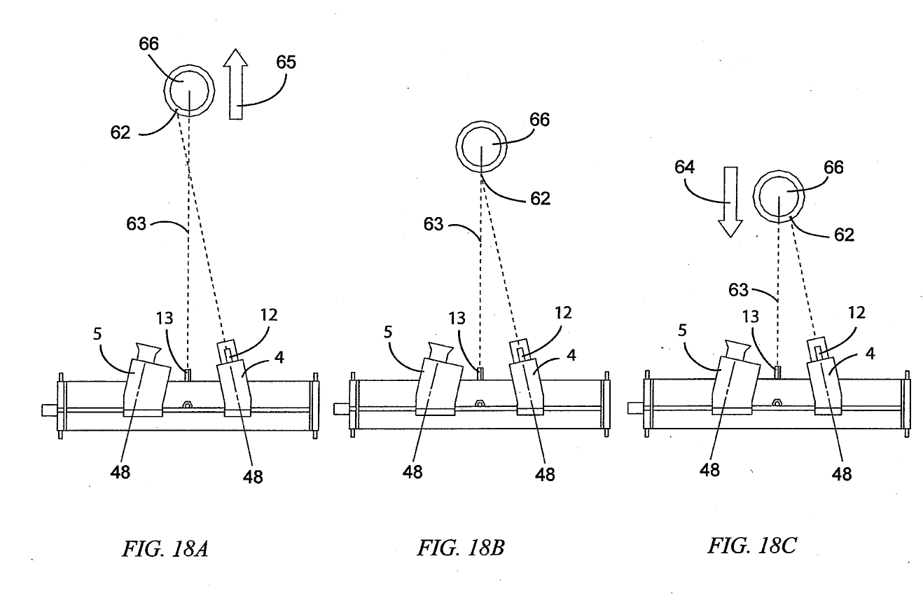

For descriptive purposes the optical devices are referred to herein as the “camera” or “projector.” A camera 4 and the projector 5 are mounted to shafts 1 and 3 with their optical axis 48 at a fixed angle 49 relative to shaft 3 as seen in orthographic views in FIGS. 18A, 18B, and 18C. The camera 4 is mated to shaft 1 by means of a fixed collar 22, such that the mated fixed collar 22 follows one of the helical grooves of shaft 1 along the rotational axis of shaft 1. The projector 5 is mated to the same shaft 1 by a fixed collar 22, such that the mated fixed collar 22 follows the “opposing” helical groove of shaft 1 along the rotational axis of shaft 1. The projector will project a series of patterns of black and white lines on the object which will be scanned while the camera captures the shape and data of the contoured lines, thus scanning the object. In other example embodiments, the projector may project other shapes and colors to the object which define the shape and contours of the object to be captured by the camera.

Additionally, both camera 4 and projector 5 are coupled to a registration collar 23. This registration collar 23 rides along the longitudinal length of the registration shaft 3, acting solely as a bearing surface and registration armature to restrict the camera 4 and projector 5 from spinning while keeping the housings parallel to the apparatus base plane at all times. Both the fixed collars 22 and the registration collars 23 are captured or otherwise connected by the camera 4 and projector 5 housings by the end caps 6 and 7 respectively and the fixed collars 22 and registration collars 23 are fixed and not allowed to rotate in any manner.

Referring to FIG. 1A as an example, as viewed with the camera 4 on the left and projector 5 on the right, as the double-opposed helical shaft 1 if rotated in a clockwise rotation along its longitudinal axis, for example, by means of turning a hand operated knob 8 coupled to shaft 1, the camera 4 and the projector 5 will move outwards away from each other in a linear motion along the longitudinal axis of shafts 1 and 3. The shaft 1 can be rotated by various means, including, but not limited to, hand operated knobs 8, a motor 9, a wirelessly actuated motor 10, or a slide lever 11 manipulated by manually sliding the camera 4 or projector 5 until the distance between optical devices desired is obtained. Once the camera 4 and projector 5 are at the outermost ends of shafts 1 and 3, as shaft 1 is turned in a counter-clockwise rotation along its longitudinal, the camera 4 and projector 5 will move inwardly towards each other in a linear motion along the longitudinal axis of shafts 1 and 3. With either the counter-clockwise and clockwise rotation of shaft 1, the camera 4 and projector 5 will always move in a symmetrical and synchronized linear direction. In other embodiments, a counter-clockwise rotation will cause the camera and the projector to move outwardly away from each other in a linear motion along the longitudinal axis of shafts 1 and 3, and a clockwise rotation will cause them to move towards each other.

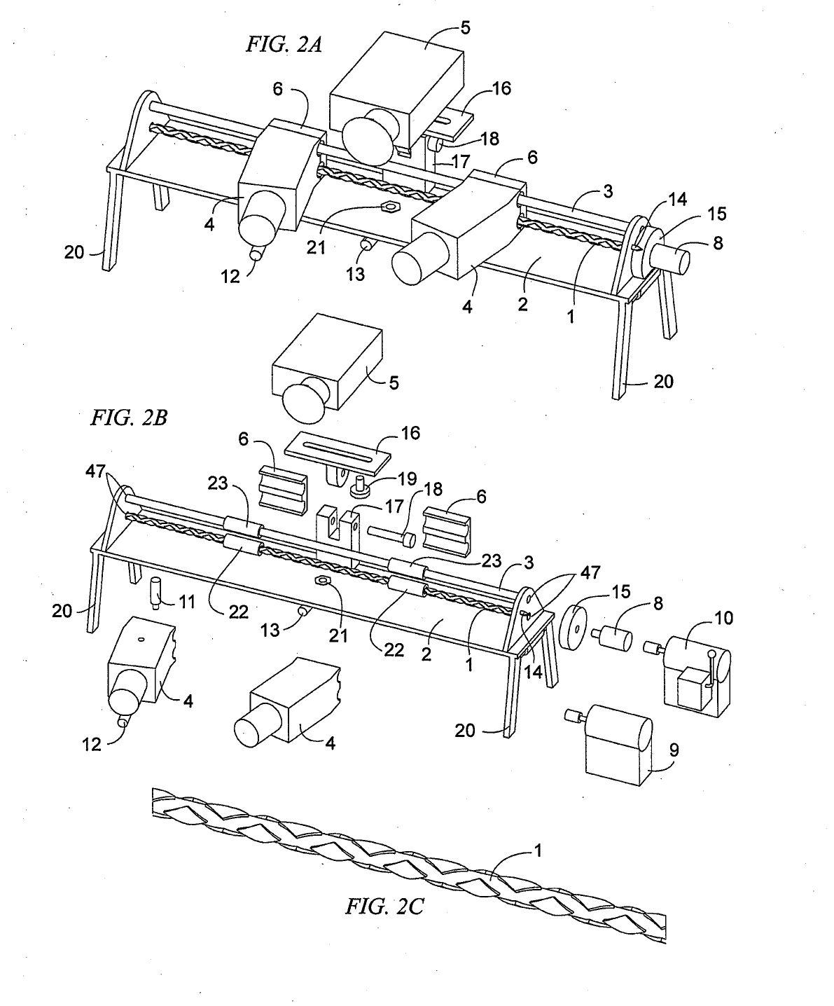

In another exemplary embodiment as shown in FIGS. 2A and 2B two cameras 4 are coupled to the double-opposed helical shaft 1 and secondary registration shaft 3 using the same drive system in the aforementioned embodiment with the primary difference being two cameras 4 are now coupled to shafts 1 and 3 rather than one camera 4 and one projector 5 shown in FIGS. 1A and 1B. In the exemplary embodiments depicted in FIGS. 2A and 2B, while the two cameras 4 move in the same manner as the camera 4 and projector 5 in FIGS. 1A and 1B, the projector 5 in FIGS. 2A and 2B is permanently coupled to the mount or fixture 2. The projector 5 is mounted and raised on a post 17 such that the projected image will not be obstructed by shafts 1 and 3 or by the cameras 4. The projector platform 16 is coupled to post 17 by projector angle fastener 18. An integrated projector 5 can be permanently affixed to the projector platform 16 or if an “off-the-shelf” projector is used, it can be attached to the projector platform 16 via tripod fastener 19. Tripod fastener 19 uses the same thread specifications as typically found on existing camera and video equipment tripods 60 that mate to a camera or projector body. Angle fastener 18 can be loosened to adjust the projection angle then retightened to set the fixed angle of the projector 5.

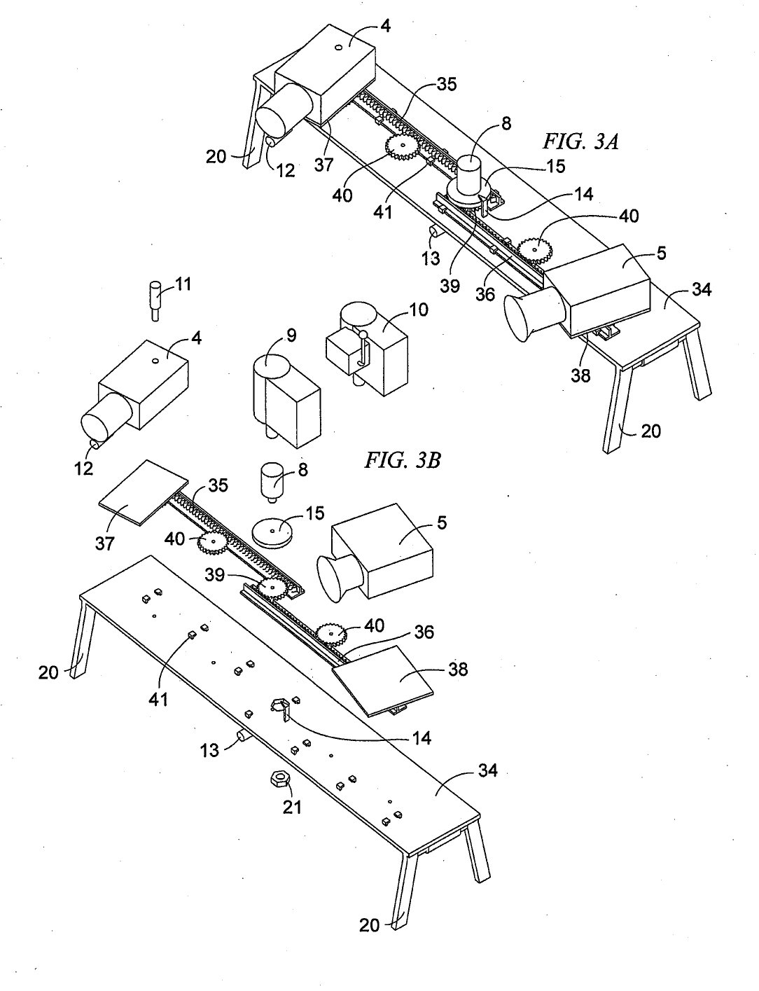

In yet another exemplary embodiment as shown in FIGS. 3A and 3B, two opposing racks 35 and 36 are driven by a primary drive gear 39, for example, by means of turning a hand operated knob 8 coupled to primary drive gear 39. The racks 35 and 36 can be moved in opposing directions by various means, including, but not limited to, hand operated knobs 8, a motor 9, a wirelessly actuated motor 10, or a slide lever 11 manipulated by manually sliding the camera 4 or projector 5 until the distance between optical devices desired is obtained. Racks 35 and 36 are aligned using alignment gears 40. Racks 35 and 36 have gear teeth molded or machined into the longitudinal length of each rack, such that the primary drive gear 39 and alignment gears 40 mate precisely to the gear-toothed racks 35 and 36. A series of alignment gears 40 insure that the racks stay parallel and precisely in constant alignment with each other. The diameter and pitch of the primary drive gear 39 and the alignment gears 40 mated to the same pitch of racks 35 and 36 can vary depending on the level of accuracy required.

Racks 35 and 36 can be coupled to a mount or fixture 34 by various means, including but not limited to, track systems, captured extrusions, various fasteners, or by retaining clips 41 as for example shown in FIG. 3A to securely fasten the racks 35 and 36 to the longitudinal flat plane of fixture 34.

As the hand-operated knob 8 coupled to the primary drive gear 39 is rotated, racks 35 and 36 move in parallel and in opposite directions from each another. For example, as viewed in FIG. 3A, the camera 4 is located on the left and the projector 5 is positioned on the right. As the hand operated knob 8 coupled to the primary drive gear 39 is turned in the clockwise rotation, the camera 4 and projector 5 begin to move towards each other until they touch. And conversely, as the hand operated knob 8 coupled to the primary drive gear 39 is turned in a counter-clockwise rotation; the camera 4 and projector 5 begin to move apart from each other until they reach the outermost edges of the fixture 34. It is understood that in other embodiments (not shown) clockwise rotation of knob 8 will cause the camera and projector to move outwardly from each other, while a counter-clockwise rotation will cause them to move towards each other. With either the counter-clockwise and clockwise rotation of the primary drive gear 39, the camera 4 and projector 5 will always move in a symmetrical and synchronized linear motion away from each other 53, 54 or towards each other 55, 56.

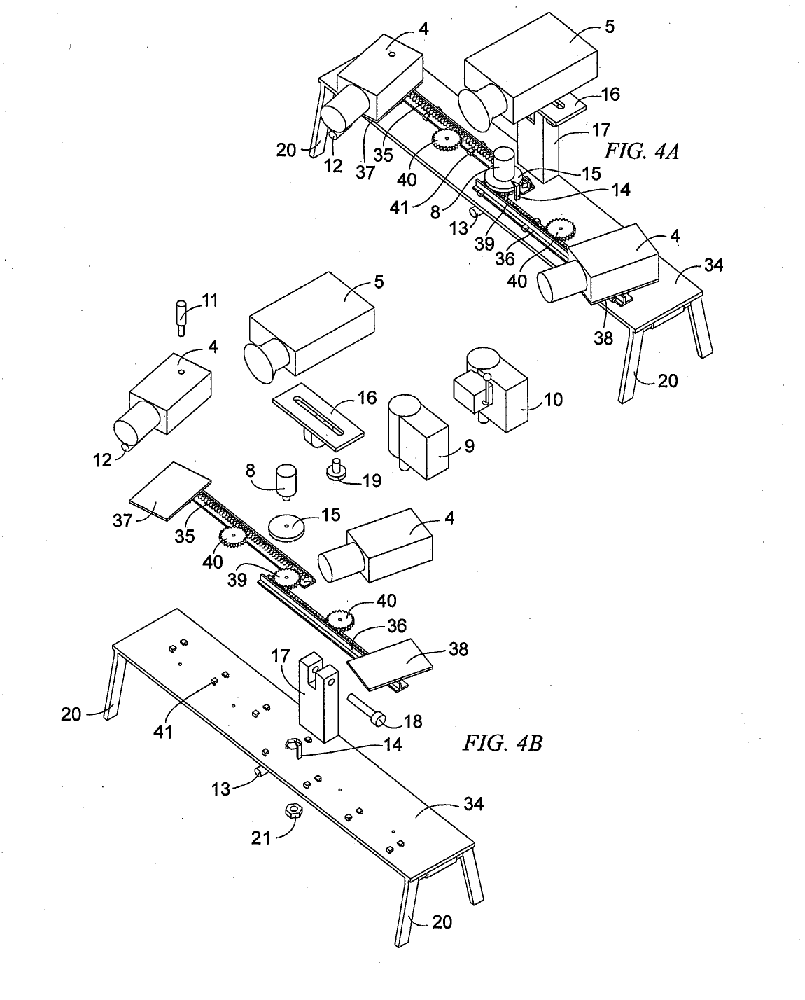

In another exemplary embodiment as shown in FIGS. 4A and 4B the same aforementioned rack drive system depicted in FIGS. 3A and 3B is used with the primary difference being one camera 4 is coupled to rack 35 and a secondary camera 4 is coupled to rack 36, rather than one camera 4 and one projector 5 shown in FIGS. 3A and 3B. In the exemplary embodiments depicted in FIGS. 4A and 4B, while the two cameras 4 move in the same manner as the camera 4 and projector 5 in FIGS. 3A and 3B, the projector 5 in FIGS. 4A and 4B is permanently coupled to the mount or fixture 2. The projector 5 is mounted and raised on a post 17 such that the projected image will not be obstructed by racks 35 and 36, or by the hand operated knob 8 and the cameras 4. The projector platform 16 is coupled to post 17 by projector angle fastener 18. An integrated projector 5 can be permanently affixed to the projector platform 16 or if an “off-the-shelf” projector is used, it can be attached to the projector platform 16 via tripod fastener 19. Tripod fastener 19 uses the same thread specifications as typically found on existing camera and video equipment tripods 60 that mate to a camera or projector body. Angle fastener 18 can be loosened to adjust the projection angle then retightened to set the fixed angle of the projector 5. With either the counter-clockwise and clockwise rotation of the primary drive gear 39, the camera 4 and projector 5 will always move in a symmetrical and synchronized linear motion away from each other 53, 54 or towards each other 55, 56.

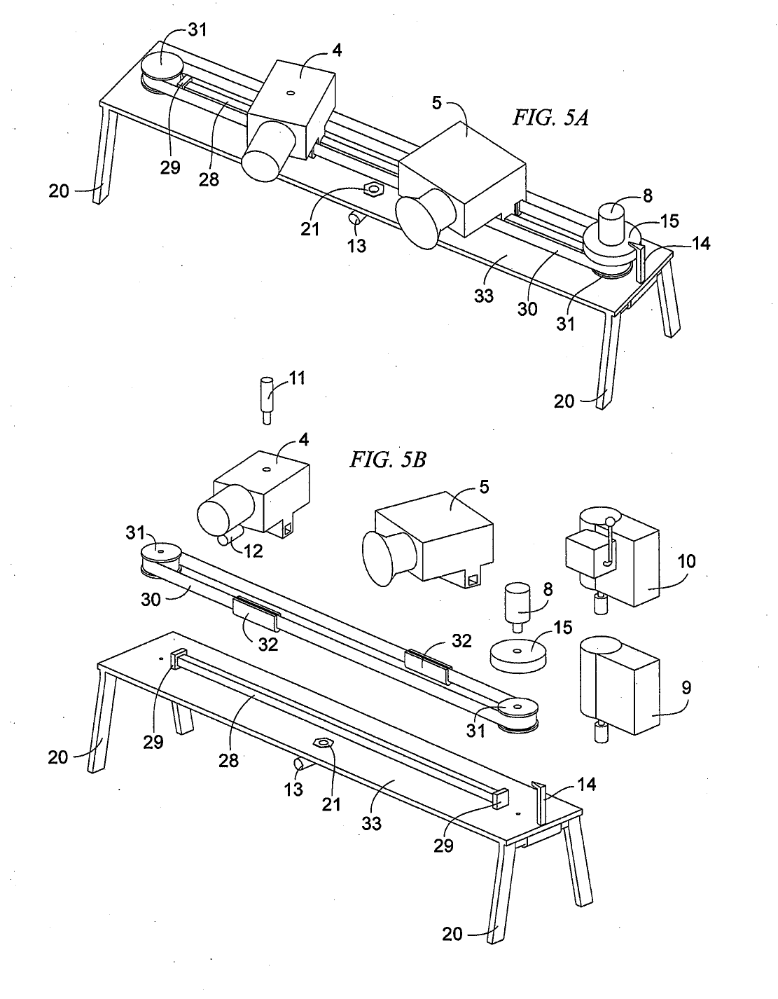

In yet another exemplary embodiment as shown in 5A and 5B, the camera 4 and projector 5 can be coupled to a continuous toothed or non-toothed belt 30. For example as viewed in FIG. 5A, the camera 4 is coupled to the front straight portion of the belt 30, and the projector 5 coupled to the rear straight portion of the belt 30. The camera 4 can be coupled to the belt 30 using a variety of methods, including, but not limited to, crimping fasteners, adhesive bonding, screw type fasteners, clips, clamping devices, or molded clamp inserts 32, as for example shown in FIG. 5B. The molded clamp inserts 32 are permanently affixed to the belt 30 then captured for example by the camera housing 4 permanently affixing the camera 4 to the belt 30. Similarly, the molded clamp inserts 32 are permanently affixed to the belt 30 then captured for example by the projector housing 5 and is permanently affixed to the belt 30. The belt 30 is tensioned and suspended by drive pulleys 31 placed at each end of the fixture 33. As an example, a hand-operated knob 8 coupled to one of the drive pulleys 31 can be rotated, thus driving the continuous belt drive with the optical devices attached in either direction while the other drive pulley 31 freewheels allowing the belt 30 to rotate freely. The drive pulleys 31 can be rotated by various means, including, but not limited to, hand operated knobs 8, a motor 9, a wirelessly actuated motor 10, or a slide lever 11 manipulated by manually sliding the camera 4 or projector 5 until the distance between optical devices desired is obtained.

As an example, as the belt 30 with the camera 4 and projector 5 rotate in either the clockwise or counter-clockwise direction, both the camera 4 and the projector 5 slide along a longitudinal registration rail or extrusion 28 supported by rail mounts 29 firmly affixed to the fixture base 33. To further aid in precise calibration, the registration rail or extrusion 28 should have a faceted cross-section, as a round cross-section would still allow a possible fore and aft motion of the camera 4 and projector 5 housings while the belt 30 is being rotated. This registration rail or extrusion 28 is a needed support structure preventing the camera 4 and projector 5 housings to rotate on the belt 30 allowing misalignment of the camera 4 and projector 5 or allowing the optical devices to “flop-around” between the front and rear straight portions of the belt 30, or within the fixture 33 itself. The rail 28 insures perpendicularity of the camera 4 and the projector 5 as each is coupled to the straight portions of the belt 30. With either the counter-clockwise and clockwise rotation of the continuous belt 30, the camera 4 and projector 5 will always move in a symmetrical and synchronized linear motion away from each other 53, 54 or towards each other 55, 56.

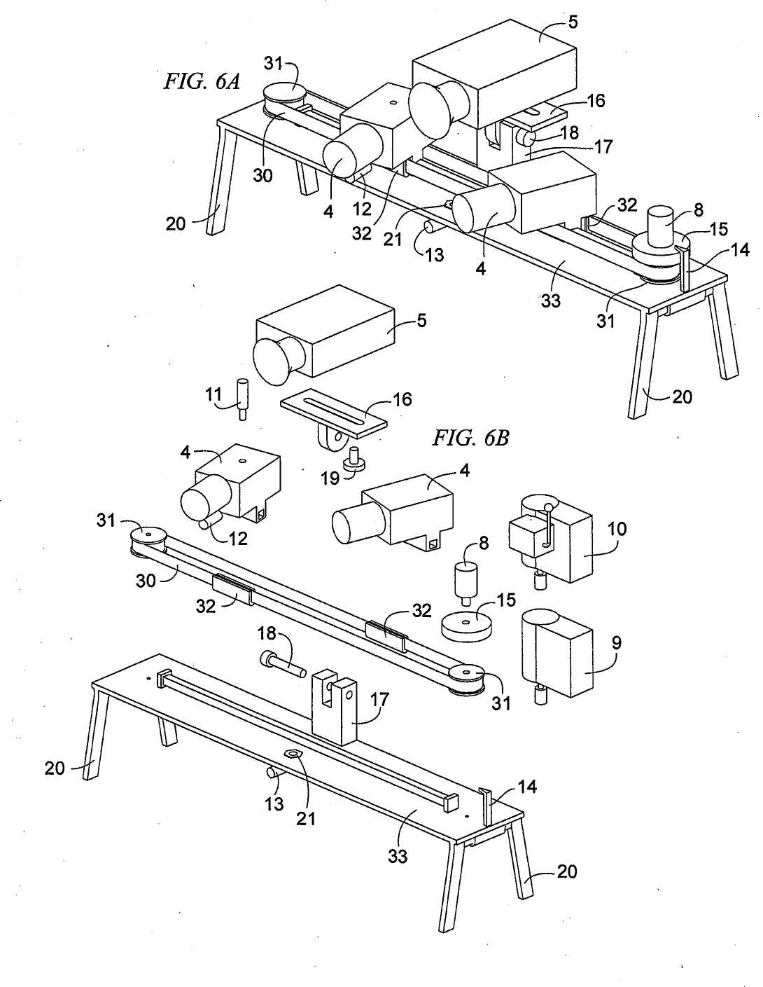

In another exemplary embodiment as shown in FIGS. 6A and 6B the same aforementioned continuous belt drive system depicted in FIGS. 5A and 5B is used with the primary difference being one camera 4 is coupled to the front straight portion of the belt 30 and a secondary camera 4 is coupled to the rear straight portion of the belt 30, rather than one camera 4 and one projector 5 shown in FIGS. 5A and 5B. In the exemplary embodiments depicted in FIGS. 6A and 6B, while the two cameras 4 move in the same manner as the camera 4 and projector 5 in FIGS. 5A and 5B, the projector 5 in FIGS. 6A and 6B is permanently coupled to the mount or fixture 33. The projector 5 is mounted and raised on a post 17 such that the projected image will not be obstructed by belt 30 or the cameras 4. The projector platform 16 is coupled to post 17 by projector angle fastener 18. An integrated projector 5 can be permanently affixed to the projector platform 16 or if an “off-the-shelf” projector is used, it can be attached to the projector platform 16 via tripod fastener 19. Tripod fastener 19 uses the same thread specifications as typically found on existing camera and video equipment tripods 60 that mate to a camera or projector body. Angle fastener 18 can be loosened to adjust the projection angle then retightened to set the fixed angle of the projector 5. With either the counter-clockwise and clockwise rotation of the belt 30, the camera 4 and projector 5 will always move in a symmetrical and synchronized linear motion away from each other 53, 54 or towards each other 55, 56.

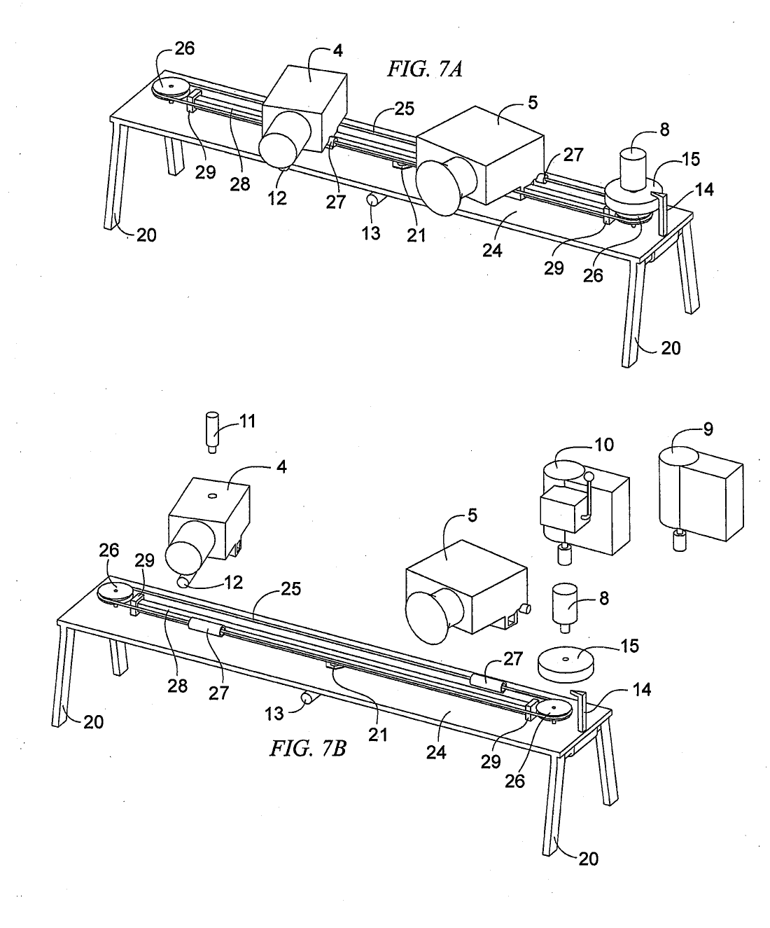

In yet a further exemplary embodiment as shown in 7A and 7B, the camera 4 and projector 5 can be coupled to a continuously looped cable 25. For example as viewed in FIG. 7A, the camera 4 is coupled to the front straight portion of the cable 25, and the projector 5 coupled to the rear straight portion of the cable 25. The camera 4 can be coupled to the cable 25 using a variety of methods, including, but not limited to, crimping fasteners, adhesive bonding, screw type fasteners, clips, clamping devices, or cable crimps 27, as for example shown in FIG. 7B. The cable crimp 27 is permanently affixed to the cable 25 then captured for example by the camera housing 4 permanently affixing the camera 4 to the cable 25. Similarly, the cable crimp 27 is permanently affixed to the cable 25 then captured for example by the projector housing 5 and is permanently affixed to the cable 25. The cable 25 is tensioned and suspended by cable drive pulleys 26 placed at each end of the fixture 24. As an example, a hand-operated knob 8 coupled to one of the cable drive pulleys 26 can be rotated, thus driving the continuously looped cable 25 with the coupled optical devices in either direction while the other cable drive pulley 26 freewheels allowing the cable 25 to rotate freely. The cable 25 can be rotated by various means, including, but not limited to, hand operated knobs 8, a motor 9, a wirelessly actuated motor 10, or a slide lever 11 manipulated by manually sliding the camera 4 or projector 5 until the distance between optical devices desired is obtained.

As an example, as the cable 25 with the camera 4 and projector 5 rotate in either the clockwise or counter-clockwise direction, both the camera 4 and the projector 5 slide along a longitudinal registration rail or extrusion 28 supported by rail mounts 29 firmly affixed to the fixture base 24. To further aid in precise calibration, the registration rail or extrusion 28 should have a faceted cross-section, as a round cross-section would still allow a possible fore and aft rotation of the camera 4 and projector 5 housings while the cable 25 is being rotated. This registration rail or extrusion 28 is a needed support structure preventing the camera 4 and projector 5 housings to rotate on the cable 25 allowing misalignment of the camera 4 and projector 5 or allowing the optical devices to “flop-around” between the front and rear straight portions of the cable 25, or within the fixture 24 itself. The rail 28 insures perpendicularity of the camera 4 and the projector 5 as each is coupled to the straight portions of the cable 25. With either the counter-clockwise and clockwise rotation of the continuously looped cable 25, the camera 4 and projector 5 will always move in a symmetrical and synchronized linear motion away from each other 53, 54 or towards each other 55, 56.

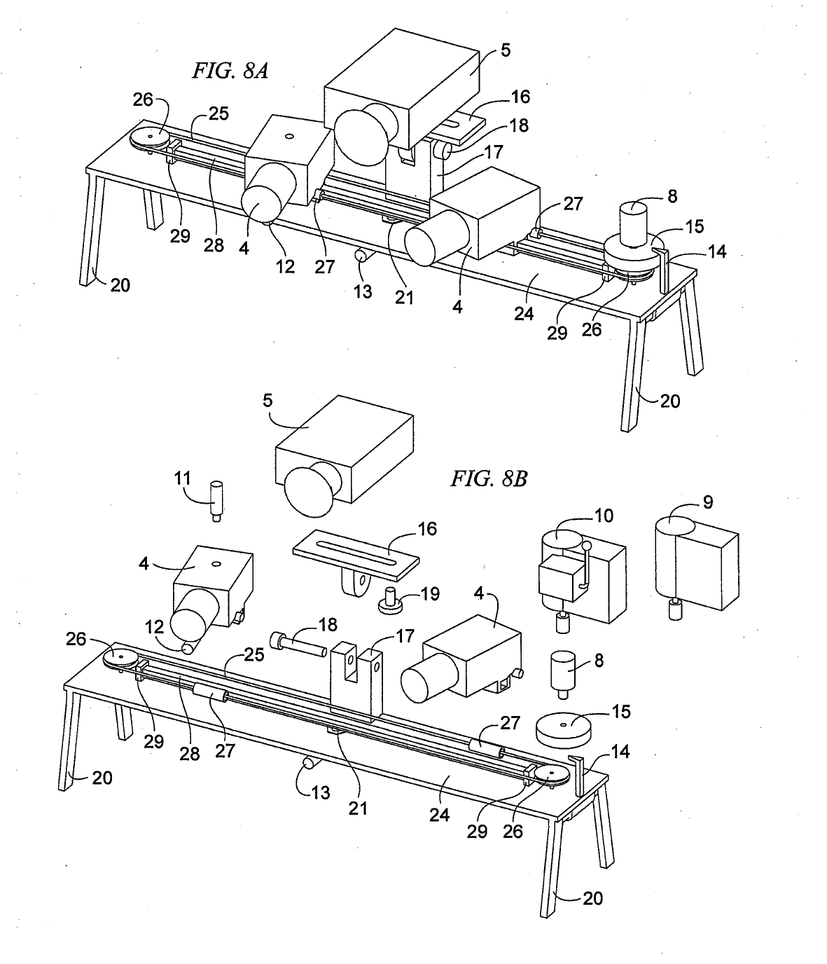

In another exemplary embodiment as shown in FIGS. 8A and 8B the same aforementioned continuously looped cable drive system depicted in FIGS. 7A and 7B is used with the primary difference being one camera 4 is coupled to the front straight portion of the cable 25 and a secondary camera 4 is coupled to the rear straight portion of the cable 25, rather than one camera 4 and one projector 5 shown in FIGS. 7A and 7B. In the exemplary embodiments depicted in FIGS. 8A and 8B, while the two cameras 4 move in the same manner as the camera 4 and projector 5 in FIGS. 7A and 7B, the projector 5 in FIGS. 8A and 8B is permanently coupled to the mount or fixture 24. The projector 5 is mounted and raised on a post 17 such that cables 25 or the cameras 4 will not obstruct the projected image. The projector platform 16 is coupled to post 17 by projector angle fastener 18. An integrated projector 5 can be permanently affixed to the projector platform 16 or if an “off-the-shelf” projector is used, it can be attached to the projector platform 16 via tripod fastener 19. Tripod fastener 19 uses the same thread specifications as typically found on existing camera and video equipment tripods 60 that mate to a camera or projector body. Angle fastener 18 can be loosened to adjust the projection angle then retightened to set the fixed angle of the projector 5. With either the counter-clockwise and clockwise rotation of the cable 25, the camera 4 and projector 5 will always move in a symmetrical and synchronized linear motion away from each other 53, 54 or towards each other 55, 56.

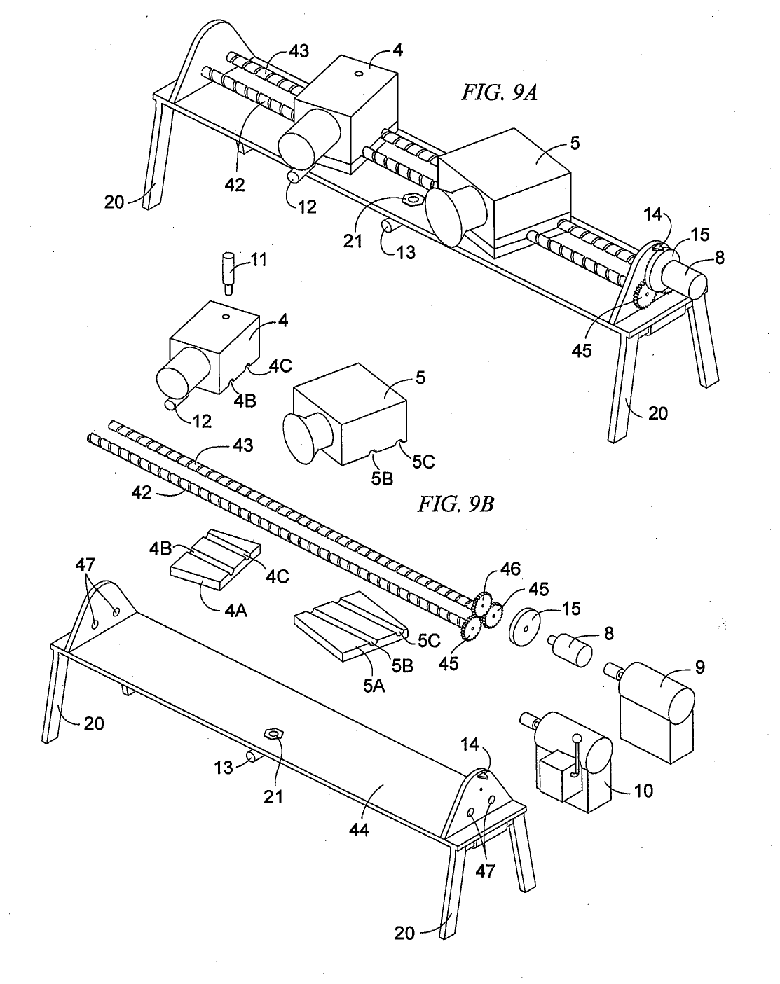

In yet another exemplary embodiment as shown in FIGS. 9A and 9B one helical-grooved shaft 42 and a secondary helical-grooved shaft 43 are positioned between two bearing surfaces 47 for precise location coupled to a mount or fixture 44. The helical-grooved shafts 42 and 43 extend approximately the length of the mount or fixture 44 in a longitudinal direction, wherein both shafts 42 and 43 are mounted at both ends of the fixture 44 allowing a majority of shafts 42 and 43 to be unobstructed. The helical-grooved shafts 42 and 43 are comprised of one helical spiral cut or groove running down the longitudinal axis of each shaft and these shafts are the core component in this exemplary embodiment to move the optical devices in one synchronized and symmetrical motion either apart from each other 53, 54 or towards each other 55, 56.

As an example as show in FIG. 9B the camera 4 is coupled to the front shaft 42, and the camera 4 captures both shafts 42 and 43 with the top camera housing 4 and the bottom housing 4A. The front positioned longitudinal hole 4B on the camera housing 4 and 4A has molded or machined into the fixed surface a track or race that follows the spiral groove of the front shaft 42 as it rotates along its longitudinal axis. The rear longitudinal hole 4C on the upper camera housing 4 and the lower camera housing 4A is solely used as a bearing surface to help prevent the camera 4 from flipping fore and aft while it tracks along shaft 42 and the camera 4 does not utilize the spiral-groove on the rear shaft 43. The rear longitudinal hole 4C also helps the camera 4 maintain its fixed angle as it slides perpendicular to the rotational axis of shaft 42. In the same embodiment, the projector 5 is coupled to the rear shaft 43, and the projector 5 captures both shafts 42 and 43 with the top projector housing 5 and the bottom housing 5A. The rear positioned longitudinal hole 5C on the projector housing 5 and 5A has molded or machined into the fixed surface a track or race that follows the spiral groove of the rear shaft 43 as it rotates along its longitudinal axis. The spiral groove on the rear shaft 43 is machined or molded in the opposite rotational direction as found on the front shaft 42. The front longitudinal hole 5B on the upper projector housing 5 and the lower projector housing 5A is solely used as a bearing surface to help prevent the projector 5 from flipping fore and aft while it tracks along shaft 43 and the projector 5 does not utilize the spiral-groove on the front shaft 42. The front longitudinal hole 5B also helps the projector 5 maintain its fixed angle as it slides perpendicular to the rotational axis of shaft 43.

The spiral-grooved shaft 42 is coupled together with a drive gear 45. The reverse spiral-grooved shaft 43 is coupled together with an identical drive gear 45. A hand-operated knob 8 is coupled to a primary drive gear 46 and acts as the main drive gear. That primary drive gear 46 is coupled to both gears 45 on shafts 42 and 43 respectively. As for example, when the primary drive gear 46 is turned via the knob 8, the shafts 42 and 43 with their respective attached gears 45 turn in the same and equal direction. The primary drive gear 46 can be rotated by various means, including, but not limited to, hand operated knobs 8, a motor 9, a wirelessly actuated motor 10, or a slide lever 11 manipulated by manually sliding the camera 4 or projector 5 until the distance between optical devices desired is obtained. As viewed in the perspective angle in FIG. 9A, as the knob 8 is turned in the clockwise rotation, both shafts 42 and 43 rotate in the counter-clockwise rotation. This motion moves the camera 4 and the projector 5 toward each other. And conversely, as the knob 8 is rotated in the counter-clockwise rotation, both shafts 42 and 43 rotate in the clockwise rotation and the camera 4 and the projector 5 move apart from each other. With either the counter-clockwise and clockwise rotation of the primary drive gear 46, the camera 4 and projector 5 will always move in a symmetrical and synchronized linear motion away from each other 53, 54 or towards each other 55, 56.

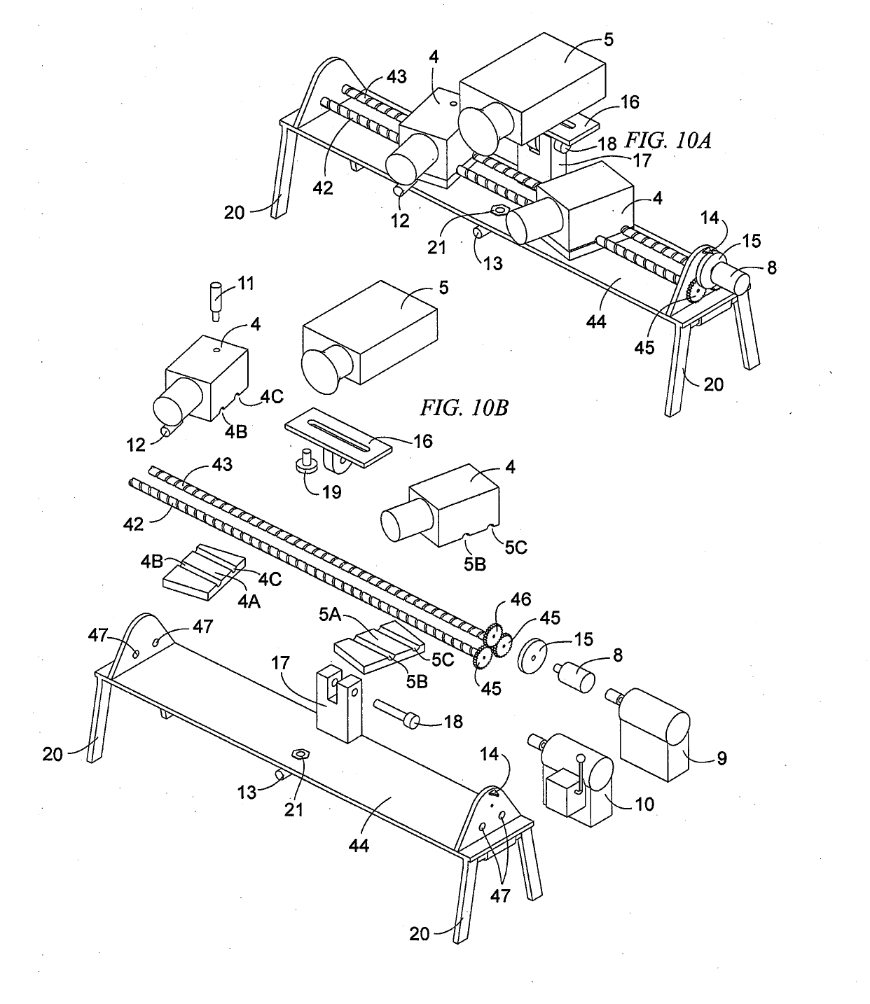

In another exemplary embodiment as shown in FIGS. 10A and 10B the same aforementioned drive system using spiral-grooved shafts 42 and 43 depicted in FIGS. 9A and 9B is used with the primary difference being one camera 4 is coupled to the front shaft 42 and a secondary camera 4 is coupled to the rear shaft 43, rather than using only one camera 4 and one projector 5 shown in FIGS. 9A and 9B. In the exemplary embodiments depicted in FIGS. 10A and 10B, while the two cameras 4 move in the same manner as the camera 4 and projector 5 in FIGS. 9A and 9B, the projector 5 in FIGS. 10A and 10B is permanently coupled to the mount or fixture 44. The projector 5 is mounted and raised on a post 17 such that the projected image will not be obstructed by shafts 42 and 43 or the cameras 4. The projector platform 16 is coupled to post 17 by projector angle fastener 18. An integrated projector 5 can be permanently affixed to the projector platform 16 or if an “off-the-shelf” projector is used, it can be attached to the projector platform 16 via tripod fastener 19. Tripod fastener 19 uses the same thread specifications as typically found on existing camera and video equipment tripods 60 that mate to a camera or projector body. Angle fastener 18 can be loosened to adjust the projection angle then retightened to set the fixed angle of the projector 5. With either the counter-clockwise and clockwise rotation of the primary drive gear 46, the camera 4 and projector 5 will always move in a symmetrical and synchronized linear motion away from each other 53, 54 or towards each other 55, 56.

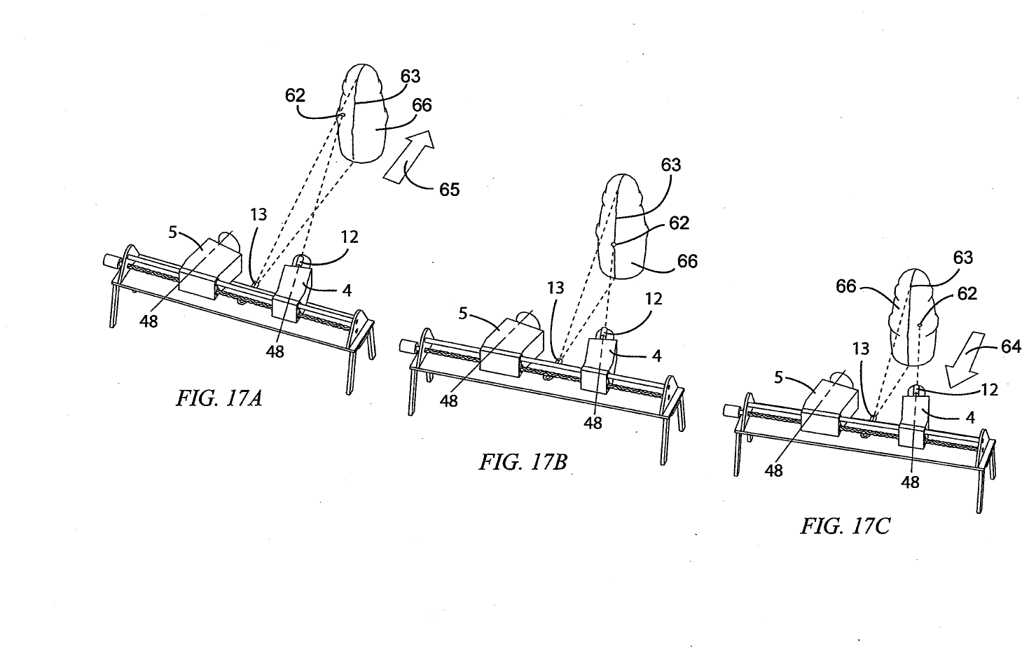

The following method can be included with any of the aforementioned embodiments as depicted in FIGS. 1A, 1B, 2A, 2B, 3A, 3B, 4A, 4B, 5A, 5B, 6A, 6B, 7A, 7B, 8A, 8B, 9A, 9B, 10A, 10B, 17A, 17B, 17C, 18A, 18B, and 18C. In an exemplary embodiment such methods enhance the setup accuracy by using a laser 12 to be coupled to one of the optical devices such as the camera 4. The laser 12 coupled to the camera housing 4 can project for example a dot pattern 62 and project the laser beam parallel to and centered on the optical axis 48 of the camera 4 lens. A secondary stationary laser 13 is coupled to and centered on any of the aforementioned fixtures perpendicular to the longitudinal length of those fixtures. The stationary laser 13 projects a beam pattern defining is a vertical line 63. As the camera 4 is moved along the longitudinal axis either left or right (FIGS. 17A, 17C, 18A and 18C) using any of the aforementioned example drive mechanisms, the dot pattern 62 projected by laser 12 at some point will intersect the vertical line 63 projected by stationary laser 13 mounted in the center of any of the aforementioned fixtures (FIGS. 17B and 18B), thus setting the proper triangulated distance between to two optical devices and the object being scanned. If the object is moved towards 64 the scanning apparatus past the point where the dot pattern 62 projected by camera mounted laser beam 12 and the vertical line 63 projected by fixture mounted stationary laser beam 13 intersect, the projected beams begin to distance themselves from one another (FIGS. 17C and 18C). Conversely, when the object is moved away 65 from the apparatus past the point where the dot pattern 62 projected by camera mounted laser beam 12 and the vertical line 63 projected by fixture mounted stationary laser beam 13 intersect, the projected beams begin to distance themselves from one another in the opposite direction (FIGS. 17A and 18A). Once the distance of the optical devices such as the camera 4 and projector 5 are calibrated on an object to be scanned, both the dot pattern 62 projected by laser 12 and the vertical line 63 projected by laser 13 are aligned, thus confirming the calibration of the optical devices camera 4 and projector 5. This distance setting between the optical devices such as a camera 4 and projector 5, or dual cameras 4, is then indicated on a display wheel 15 by means of a pointer 14. The display wheel 15 can show the number of rotations of any of the aforementioned actuators, including, but not limited to, manual knobs 8, motors 9, wirelessly actuated motors 10, or slide levers 11, by a series of numbers, letters, symbols, or icons (collectively or individually referred to as “markings”) on the display wheel 15. The markings can also indicate the distance the optical devices have been moved apart from each other which determines the distance between the scanner and the intersection point of dot pattern 62 and vertical line 63. The display wheel has the reference markings on its circumference or proximate its circumference. As the wheel rotates, the pointer will point to a different marking that may indicate for example, the distance the optical devices have been moved apart. The indicated reference marking on the display wheel 15 by the pointer 14 then allows the user to replicate scanning the same object again without the need to recalibrate the optical devices used to scan the object.

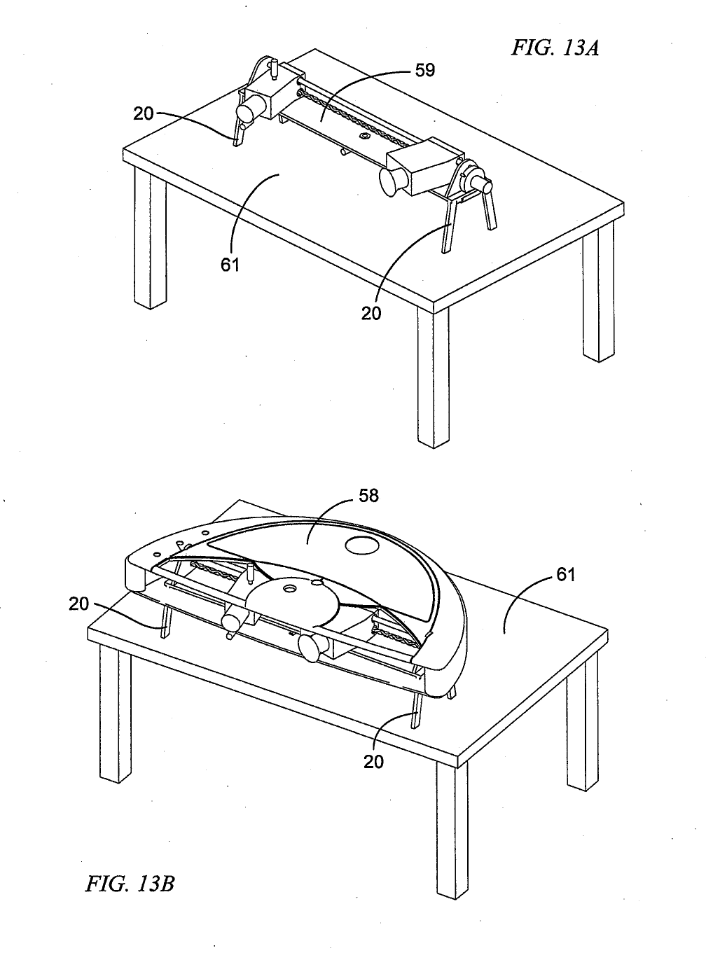

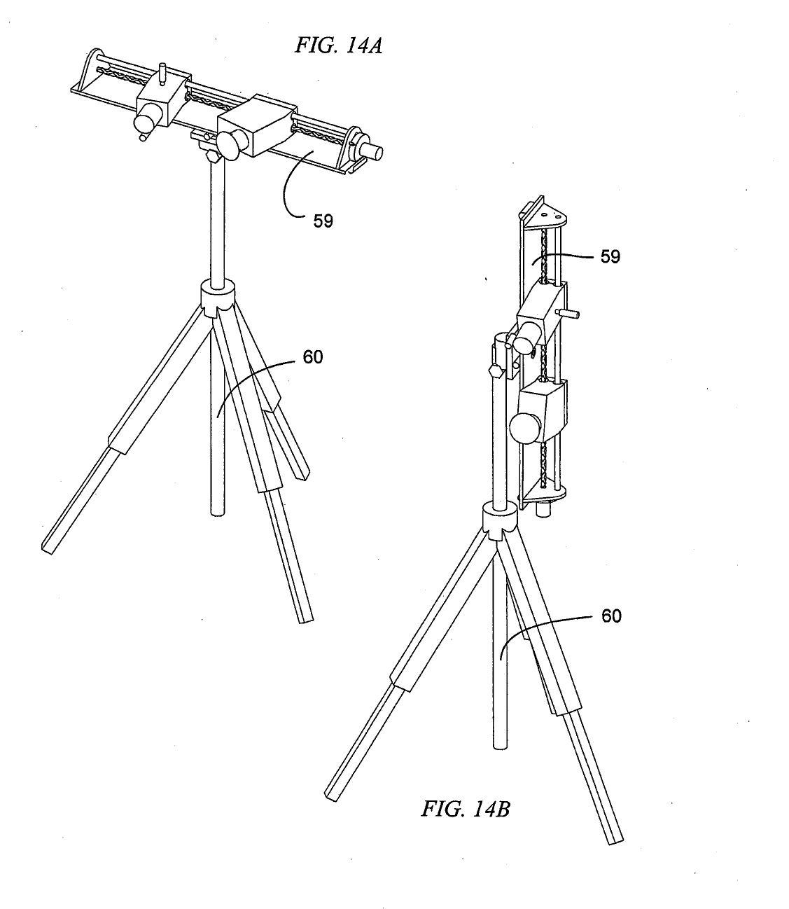

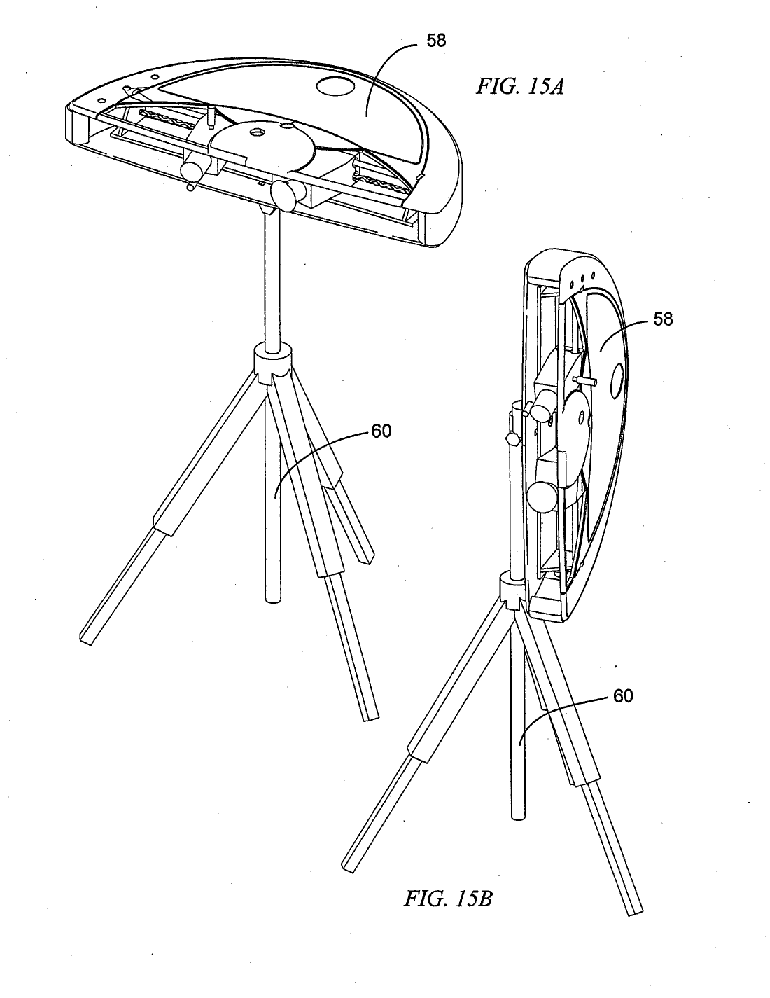

Support legs 20 can be utilized to further stabilize any of the aforementioned fixtures, including, but not limited to, folding leg supports 20, fixed stationary legs supports, telescopic feet, adjustable feet, or stationary feet. As an example, the functional apparatus without an enclosed housing (i.e., an open housing 59) with legs 20 is used to stabilize the apparatus is shown in FIG. 13A placed horizontally on a flat surface such as a table. As yet another example, an apparatus with an enclosed housing 58 with legs 20 used to stabilize the apparatus is shown in FIG. 13B placed horizontally on a flat surface such as a table. As another example, a tripod nut 21 can be molded into all of the aforementioned fixtures allowing the apparatus to be attached to most any universal tripod 60 used with cameras or video equipment. As a further example, all aforementioned fixtures with a molded-in tripod nut 21 can be mounted on a tripod 60 to scan an object either horizontally as shown in FIGS. 14A and 15A or vertically mounted as shown in FIGS. 14B and 15B.

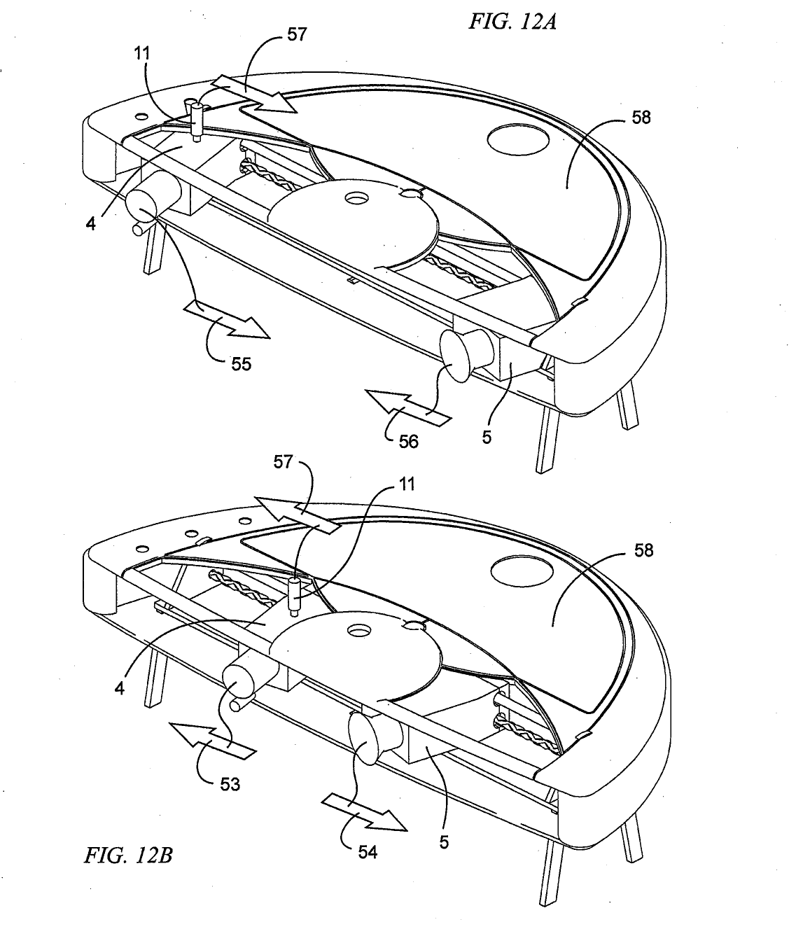

All aforementioned embodiments for example may be utilized with or without an enclosed housing as seen in FIGS. 12A, 12B, 13A, 13B, 15A, and 15B. As a further example, an apparatus that functions without an enclosed housing 59 can be attached to any tripod 60 and any off-the-shelf camera 4 or projector 5 can be mounted onto any of the aforementioned apparatus fixtures. The apparatus without an enclosed housing 59 can be placed on any surface without the use of a tripod 60, for example on a table 61 or on the ground. The apparatus with an enclosed housing 58 can be placed on any surface without the use of a tripod 60, for example on a table 61 or on the ground.

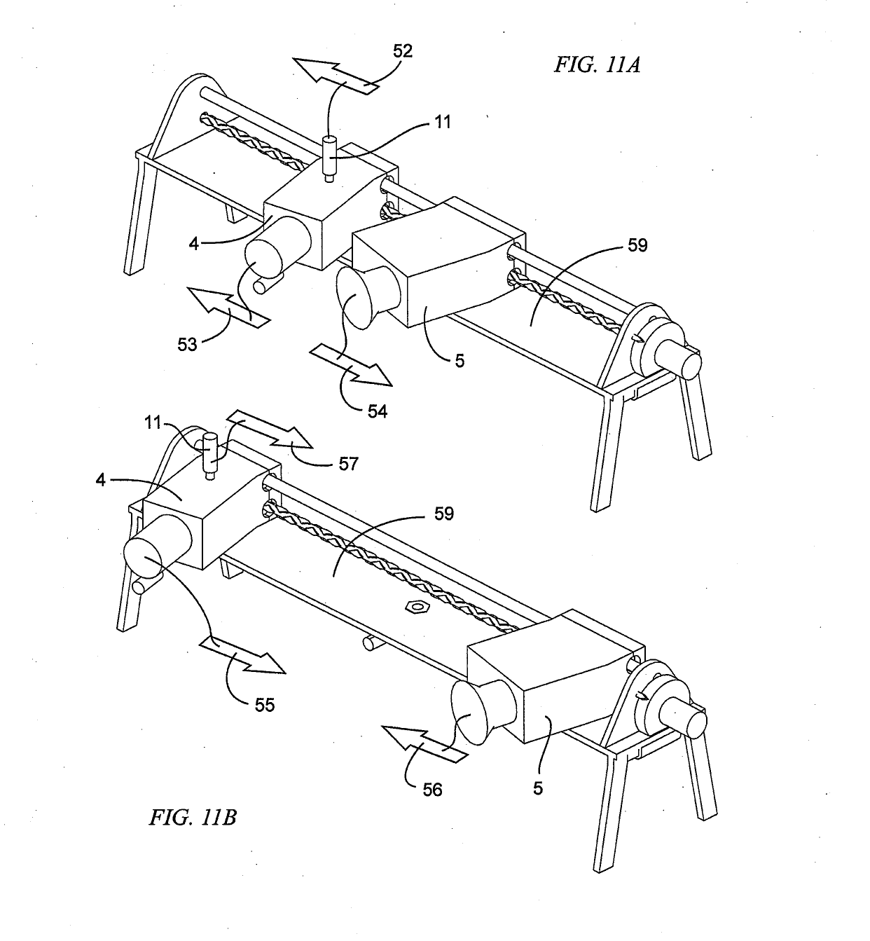

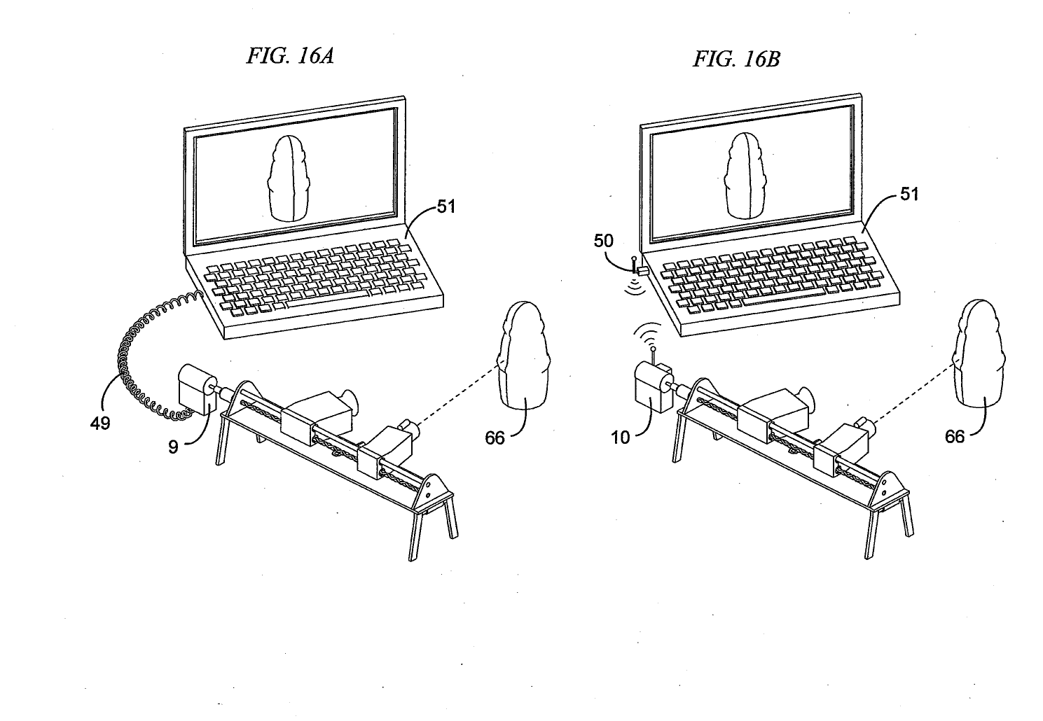

All aforementioned embodiments may use a variety of actuators coupled to the drive mechanism to move the optical devices apart from each other or closer to each other during the triangulation process. Examples to actuate the mechanism, include, but are not limited to, hand operated knobs 8, a motor 9, a wirelessly actuated motor 10, or a slide lever 11. As an example, as shown in FIGS. 11A, 11B, 12A, and 12B, the optical devices can be moved and adjusted in a linear motion by means of a simple hand-operated slide lever 11 coupled to the camera 4. This method will work with either a fully functioning fixture without an enclosed housing (i.e., an open housing 59), or a fixture with an enclosed housing 58. As seen in FIGS. 11A, 11B, 12A, and 12B as the lever 11 is pushed for example in an outward direction 52, the camera 4 will move in the same outward direction 53 as the lever 11 being pushed. Conversely, the opposing optical device, either a projector 5 or another camera 4 will move simultaneously and automatically in the opposite and outward direction 54 on the same longitudinal axis of the apparatus. As such, one motion pushing the lever 11 in a linear and outward motion 52 will simultaneously move both optical devices 4, 5 in either an outward 53, 54 or inward 55, 56 direction. As seen in FIGS. 12A and 12B the lever 11 can protrude from the apparatus housing to access the lever 11 such that the user's fingers can grasp the lever 11 and move it laterally along the mechanism's axis in either direction without any obstructions. As seen in yet another example shown in FIGS. 16A and 16B, a wirelessly actuated motor 10 that can drive the drive mechanism may transmit data and instructions from the computer 51 to the scanner and vice versa. As a further example, the computer 51 and scanner can transmit data to each other using a variety of wireless technologies including, but not limited to, a wireless card 50, wireless technologies such as Bluetooth or other wireless technologies, or the computer 51 can be hard-wired to the apparatus via cables 49 using various connectors, including, but not limited to, any USB connectors, Firewire connectors, HDMI connectors, or proprietary connectors.

The preceding description has been presented with reference to example embodiments of the invention. Persons skilled in the art and technology to which this invention pertains will appreciate that alterations and changes in the described structures and methods of operation can be practiced without meaningfully departing from the principal, spirit and scope of this invention. Accordingly, the foregoing description should not be read as pertaining only to the precise structures and methods described and shown in the accompanying drawings.

What is claimed is:

1. A three dimensional scanning apparatus comprising:
a camera moveable along a first longitudinal axis; and
a projector moveable along a second longitudinal axis which is parallel or coincident with the first longitudinal axis, wherein movement of one of said camera and projector along its corresponding longitudinal axis toward the other of said camera and projector causes said other of said camera and projector to move along its corresponding longitudinal axis toward said one of said camera and projector.

2. The apparatus of claim 1 further comprising a moveable member wherein movement of said movable member in a first direction causes said camera to move toward said projector along the first longitudinal axis and said projector to move toward said camera along the second longitudinal axis.

3. The apparatus of claim 2 wherein movement of said movable member in a second direction opposite the first direction causes said camera to move away from said projector along the first longitudinal axis and said projector to move away from said camera along said second longitudinal axis.

4. The apparatus of claim 1 wherein said camera is linked with said projector by a helically grooved shaft which is rotatable about a shaft longitudinal axis.

5. The apparatus of claim 4 further comprising:
a first collar having an first inner grooved surface mating with an outer helically grooved surface of said shaft, wherein rotation of said shaft in a first direction about its longitudinal axis causes the first collar to translate in a first direction along said shaft longitudinal axis; and
a second collar having an first inner grooved surface mating with an outer helically grooved surface of said shaft, wherein rotation of said shaft in a first direction about its longitudinal axis causes the second collar to translate in a second direction opposite the first direction along said shaft longitudinal axis.

6. The apparatus of claim 5 wherein the first collar is coupled to the camera and the second collar is coupled to the projector.

7. The apparatus of claim 5 wherein the first collar is integral with the camera and the second collar is integral with the projector.

8. The apparatus of claim 1 wherein said camera is linked with said projector with first rack, a second rack, and a pinion, wherein the camera is coupled to the first rack, the projector is coupled to the second rack, and wherein the pinion is coupled to both racks, wherein rotation of the pinion in a first direction causes the two racks and thus the camera and projector to move toward each other along their corresponding longitudinal axes, and rotation of the pinion in a second direction opposite the first direction causes the racks and thus the camera and projector to move away from each other along their longitudinal axes.

9. The apparatus of claim 1 wherein said camera is linked to said projector by a belt, wherein the belt is continuous belt wrapped around two pulleys defining a first portion of the belt between the pulleys and a second portion of the belt between the pulleys opposite the first portion, wherein the camera is coupled to the first portion of the belt and the projector is coupled to the second portion of the belt, wherein rotation of the belt around the pulleys in a first direction causes the camera and projector to move toward each other along their corresponding longitudinal axes, and wherein rotation of the pulleys in a second direction opposite the first direction causes the camera and the projector to move away from each other along their corresponding longitudinal axes.

10. The apparatus of claim 9 wherein said belt is defined by a cable.

11. The apparatus of claim 1 wherein the camera is linked with the projector with a first threaded shaft having a first longitudinal axis and a second threaded shaft having a second longitudinal axis, wherein the first threaded shaft is coupled to a threaded opening through said camera and the second threaded shaft is coupled to a second threaded opening through said projector, the apparatus further comprising a gear coupled to the first and second shafts, wherein rotation of the gear in a first direction causes the first shaft to rotate in a second direction about the first longitudinal axis and the camera to translate along the first threaded shaft toward the projector and causes the second longitudinal shaft to rotate in a third direction about said second longitudinal axis and the projector to translate along the second longitudinal shaft toward the camera, and wherein rotation of the gear in a fourth direction opposite the first direction causes the first shaft to rotate in a fifth direction opposite the second direction about the first longitudinal axis and the camera to translate along the first threaded shaft away from the projector and causes the second longitudinal shaft to rotate in a sixth direction opposite the third direction about said second longitudinal axis and the projector to translate along the second longitudinal shaft away from the camera.

12. A three dimensional scanning apparatus comprising:
a first camera moveable along a first longitudinal axis;
a second camera moveable along a second longitudinal axis which is parallel or coincident with the first longitudinal axis, wherein movement of said first camera along the first longitudinal axis toward the second camera causes the second camera to move toward the first camera along the second longitudinal axis; and
a projector.

13. The apparatus as recited in claim 12 wherein the projector is located between the first and second cameras.

14. The apparatus of claim 12 further comprising a moveable member wherein movement of said movable member in a first direction causes said first camera to move toward said second camera along the first longitudinal axis and said second camera to move toward said first camera along the second longitudinal axis.

15. The apparatus of claim 14 wherein movement of said movable member in a second direction opposite the first direction causes said first camera to move away from said second camera along the first longitudinal axis and said second camera to move away from said first camera along said second longitudinal axis.

16. The apparatus of claim 12 wherein said first camera is linked with said second camera by a helically grooved shaft which is rotatable about a shaft longitudinal axis.

17. The apparatus of claim 16 further comprising:
a first collar having an first inner grooved surface mating with an outer helically grooved surface of said shaft, wherein rotation of said shaft in a first direction about its longitudinal axis causes the first collar to translate in a first direction along said shaft longitudinal axis; and
a second collar having an first inner grooved surface mating with an outer helically grooved surface of said shaft, wherein rotation of said shaft in a first direction about its longitudinal axis causes the second collar to translate in a second direction opposite the first direction along said shaft longitudinal axis.

18. The apparatus of claim 17 wherein the first collar is coupled to the first camera and the second collar is coupled to the second camera.

19. The apparatus of claim 17 wherein the first collar is integral with the first camera and the second collar is integral with the second camera.

20. The apparatus of claim 12 wherein said first camera is linked with said second camera with first rack, a second rack and a pinion, wherein the first camera is coupled to the first rack, the second camera is coupled to the second rack, and wherein the pinion is coupled to both racks, wherein rotation of the pinion in a first direction causes the two racks and thus the first camera and second camera to move toward each other along their corresponding longitudinal axes, and rotation of the pinion in a second direction opposite the first direction causes the racks and thus the first camera and second camera to move away from each other along their longitudinal axes.

21. The apparatus of claim 12 wherein said first camera is linked to said second camera by a belt, wherein the belt is continuous belt wrapped around two pulleys defining a first portion of the belt between the pulleys and a second portion of the belt between the pulleys opposite the first portion, wherein the first camera is coupled to the first portion of the belt and the second camera is coupled to the second portion of the belt, wherein rotation of the belt around the pulleys in a first direction causes the first camera and second camera to move toward each other along their corresponding longitudinal axes, and wherein rotation of the pulleys in a second direction opposite the first direction causes the first camera and the second camera to move away from each other along their corresponding longitudinal axes.

22. The apparatus of claim 21 wherein said belt is defined by a cable.

23. The apparatus of claim 12 wherein the first camera is linked with the second camera with a first threaded shaft having a first longitudinal axis and a second threaded shaft having a second longitudinal axis, wherein the first threaded shaft is coupled to a threaded opening through said first camera and the second threaded shaft is coupled to a second threaded opening through said second camera, the apparatus further comprising a gear coupled to the first and second shafts, wherein rotation of the gear in a first direction causes the first shaft to rotate in a second direction about the first longitudinal axis and the first camera to translate along the first threaded shaft toward the second camera and causes the second longitudinal shaft to rotate in a third direction about said second longitudinal axis and the second camera to translate along the second longitudinal shaft toward the first camera, and wherein rotation of the gear in a fourth direction opposite the first direction causes the first shaft to rotate in a fifth direction opposite the second direction about the first longitudinal axis and the first camera to translate along the first threaded shaft away from the second camera and causes the second longitudinal shaft to rotate in a sixth direction opposite the third direction about said second longitudinal axis and the second camera to translate along the second longitudinal shaft away from the first camera.

24. A method for calibrating the location of a camera and a projector for three dimensional scanning of an object, the method comprising:
projecting a vertical line on the object;
projecting a light beam parallel to an optical axis of said camera
moving the camera along a first longitudinal axis toward a projector until said light beam intersects said line; and
moving the projector synchronously with said moving of said camera toward the camera along a second longitudinal axis which is parallel or coincident with the first longitudinal axis.

25. The method of claim 24 wherein said light beam is a laser beam and wherein said line is formed by a laser beam.

26. A method for calibrating the location of two cameras for three dimensional scanning of an object, the method comprising:
projecting a vertical line on the object;
projecting a light beam parallel to an optical axis of a first camera
moving the first camera along a first longitudinal axis toward a second camera until said light beam intersects said line; and
moving the second camera synchroshously with said moving of said first camera toward the first camera along a second longitudinal axis which is parallel or coincident with the first longitudinal axis.

27. The method of claim 24 wherein said light beam is a laser beam and wherein said line is formed by a laser beam.
